(19) United States
(12) Patent Application Publication
(10) Pub. No.: US 2012/0178301 A1
(43) Pub. Date: Jul. 12, 2012

(54) MEMORY CONNECTOR

(75) Inventor: XIANG CAO, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/011,916

(22) Filed: Jan. 23, 2011

(30) Foreign Application Priority Data
Jan. 10, 2011 (CN) 201110003867.9

(51) Int. Cl. H01R 24/00

(52) U.S. Cl. 439/631; 439/630

(57) ABSTRACT

An assembly of connectors for memory cards includes a number of connectors. Each connector includes a main body longitudinally defining a slot therein into which a memory card is inserted, and two fixing members respectively extending from opposite ends of the main body. A post and a receiving portion respectively extend from opposite sides of each fixing member. The posts of one connector are engaged in the receiving portions of an adjacent connector.

### BACKGROUND

1. Technical Field

The present disclosure relates to a memory connector.

2. Description of Related Art

Memory connectors are often used to insert memories into memory slots of a circuit board in a computer. However, in use, the memories must be respectively inserted into the corresponding connectors, and then are inserted into the corresponding memory slots in the circuit board one by one, which is inconvenient.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a connector and a memory card.

FIG. 2 is similar to FIG. 1, but viewed from another perspective.

FIG. 3 is an assembled, isometric view of a use state of an assembly of a plurality of connectors and the memory cards of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

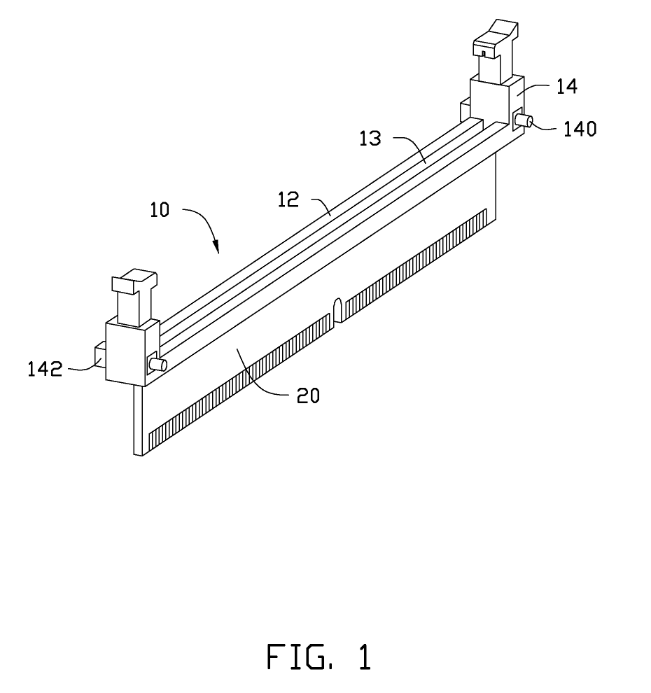

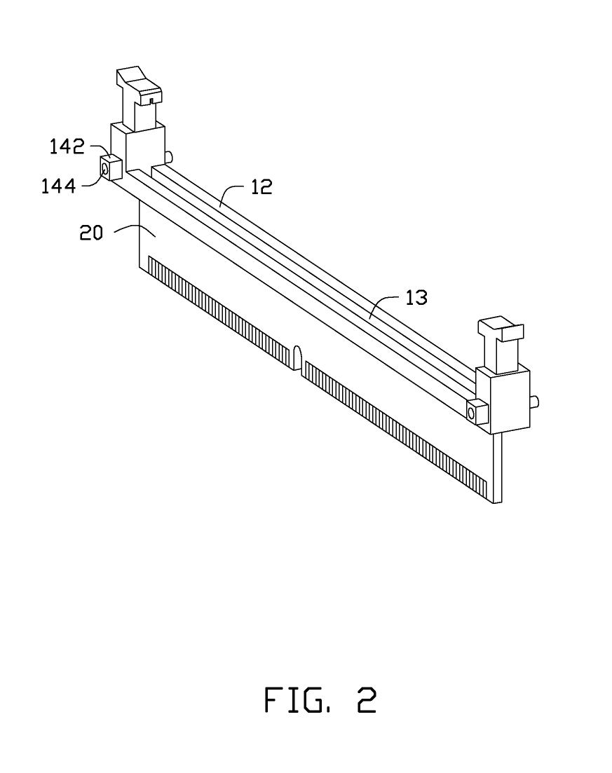

Referring to FIGS. 1 and 2, an exemplary embodiment of a connector 10 for a memory card 20 includes a bar-shaped main body 12 longitudinally defining a slot 13 therein, into which a memory card 20 is inserted, and two fixing members 14 respectively extending up from opposite ends of the main body 12.

A post 140 and a receiving portion 142 respectively extend from opposite side of each fixing member 14. A fixing hole 144 is defined in a center of each receiving portion 142 to receive a post with the same configuration as the post of each of the fixing member.

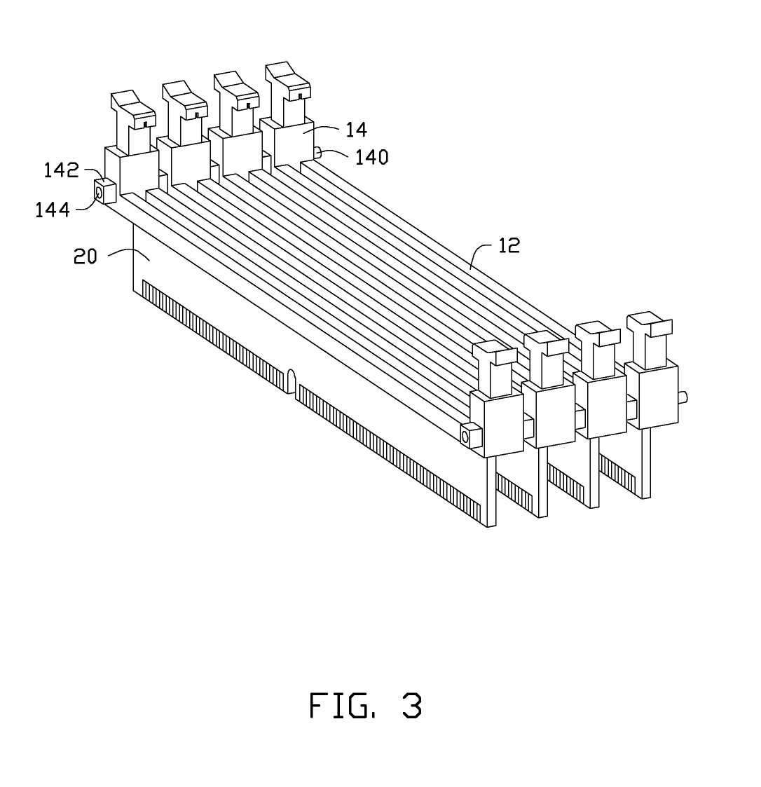

Referring to FIG. 3, in use, the posts 140 of one connector 10 are received in the corresponding fixing holes 144 of an adjacent connector 10. Thereby, a plurality of connectors 10 are connected together side by side.

A plurality of memory cards 20 are respectively inserted into the slots 13 of the connectors 10, then the memory cards 20 can be inserted into corresponding memories slots of a circuit board at the same time.

It is believed that the present embodiments and their advantages will be understood from the foregoing description, and they will be apparent that various changes may be made thereto without departing from the spirit and scope of the description or sacrificing all of their material advantages, the examples hereinbefore described merely being exemplary embodiment.

What is claimed is:

1. A connector for a memory card, the connector comprising:
a bar-shaped main body longitudinally defining a slot therein into which the memory card is inserted; and
two fixing members respectively extending from opposite ends of the main body, a post and a receiving portion respectively extending from opposite sides of each fixing member, the receiving portion defining a fixing hole to receive a post with the same configuration as the post of each of the fixing members.

2. An assembly for a plurality of memory cards, the assembly comprising:
a plurality of connectors each comprising a bar-shaped main body longitudinally defining a slot therein into which a corresponding memory card inserted, and two fixing members extending from opposite ends of the main body; wherein a post and a receiving portion extend from opposite sides of each fixing member, the posts of one connector are correspondingly engaged in the receiving portions of an adjacent connector.

3. The assembly of claim 2, wherein the receiving portion of each fixing member of each connector defines a fixing hole to receive the corresponding post of an adjacent connector.
